(19) United States
(12) Patent Application Publication
(10) Pub. No.: US 2026/0280615 A1
(43) Pub. Date: Sep. 17, 2026

(54) METHOD OF COMPENSATING FOR A TIME DELAY OF AN INFORMATION SIGNAL, COMPUTER PROGRAM PRODUCTS, NON-TRANSITORY COMPUTER-READABLE STORAGE MEDIUM, CONTROL UNIT, WIRELESS DEVICE, AND CHIPS THEREFOR

(71) Applicant: BEAMMWAVE AB, Lund (SE)

(72) Inventors: Joakim Axmon, Limhamn (SE); Bengt Lindoff, Bjärred (SE)

(21) Appl. No.: 19/471,199

(22) PCT Filed: Apr. 3, 2024
(86) PCT No.: PCT/SE2024/050301

§ 371 Date: Sep. 30, 2025

(30) Foreign Application Priority Data
Apr. 5, 2023 (SE) 2330153-4

(51) Int. Cl. H04B 7/0413

(52) U.S. Cl. CPC H04B 7/0413

(57) ABSTRACT

A method of compensating for a time delay of an information signal comprised in a radio signal received by different antenna units of a multi-antenna transmitter and receiver arrangement, MATARA, the method comprising: receiving a first oversampled signal wherein the first oversampled signal is an oversampled representation of the information signal received by a first antenna unit obtaining a first time delay of the first oversampled signal relative a second oversampled signal, wherein the second oversampled signal is an oversampled representation of the information signal received by a second antenna unit; obtaining a down-sampling (DS) offset based on the first time delay; and configuring a first down-sampling (DS) unit to down-sample the first oversampled signal to a first down-sampled signal in accordance with the down-sampling offset, the first DS unit thereby compensating the first down-sampled signal for the time delay of the first oversampled signal relative the second oversampled signal. Corresponding computer program product, control unit, wireless device, and chips are also disclosed.

### TECHNICAL FIELD

The present disclosure relates to a method of compensating for a time delay of an information signal, computer program products, a non-transitory computer-readable storage medium, a control unit, a wireless device, and a chip therefor.

More specifically, the disclosure relates to a method of compensating for a time delay of an information signal, computer program products, a non-transitory computer-readable storage medium, a control unit, a wireless device, and a chip as defined in the introductory parts of the independent claims.

### BACKGROUND ART

In a distributed digital beamforming antenna system operating in a millimeter wave (mmW) spectrum, the time delay of a received signal at different antennas (located apart from each other) may differ, e.g., in power limited handheld devices. In a multiple input, multiple output (MIMO) system such a time delay needs to be compensated for prior to phase-coherent combining of signals from the different antennas for improved/optimized system performance.

Therefore, there is a need for compensation, e.g., of a time delay between radio signals received by different antennas (e.g., in a wireless device).

U.S. Pat. No. 6,111,816 A discloses compensation of a delay. However, there may be a need for improving the compensation, e.g., by providing a lower complexity system, by providing compensation separate from a converter unit, by providing a more flexible/variable compensation and/or by providing a higher resolution/accuracy.

Furthermore, US 2005/0271123 A1 discloses a method for a multi-branch wireless receiver for periodically sampling first and second received signals corresponding to first and second receiver branches at first and second sample times to generate offset sample streams, which are then combined in a combining circuit to reduce interference present in the received signals. However, US 2005/0271123 A1 does not disclose any compensation of a time delay between radio signals received by different antennas.

### SUMMARY

An object of the present disclosure is to mitigate, alleviate or eliminate one or more of the above-identified deficiencies and disadvantages in the prior art and/or solve at least the above-mentioned problem or other problems.

According to a first aspect there is provided a method of compensating for a time delay of an information signal comprised in a radio signal received by different antenna units of a multi-antenna transmitter and receiver arrangement (MATARA), the method comprising: receiving, at a first down-sampling (DS) unit, a first oversampled signal, the first oversampled signal is an oversampled representation of the information signal received by a first antenna unit; obtaining a first time delay of the first oversampled signal relative a second oversampled signal, the second oversampled signal is an oversampled representation of the information signal received by a second antenna unit; obtaining, by the control unit, a DS offset based on the first time delay; and configuring, by the control unit, a first DS unit to down-sample the first oversampled signal to a first down-sampled signal in accordance with the down-sampling offset, the first DS unit thereby compensating the first down-sampled signal for the time delay of the first oversampled signal relative the second oversampled signal.

According to some embodiments, obtaining a first time delay of the first oversampled signal relative a second oversampled signal is performed by the control unit.

According to some embodiments, the first oversampled signal comprises two or more groups of samples, each group comprising or consisting of a first and a second sample, and configuring the first DS unit to down-sample the first oversampled signal to a first down-sampled signal in accordance with the DS offset comprises: configuring the first DS unit to select for every group of samples either the first sample or the second sample in accordance with the DS offset, thereby compensating the first down-sampled signal for the time delay of the first oversampled signal relative the second oversampled signal.

According to some embodiments, oversampling is performed with a first factor and each group of the two or more groups of samples comprises a number of samples, the number of samples is two or more, and the number of samples of each group of the two or more groups of samples is selected so that the average down sampling for the two or more groups of samples is in accordance with the first factor.

According to some embodiments, the method further comprises configuring a second DS unit to down-sample the second oversampled signal to a second down-sampled signal; configuring a combiner to combine the second down-sampled signal with the first down-sampled signal to obtain a combined down-sampled signal; and utilizing the combined down-sampled signal as a representation of the information signal.

According to some embodiments, compensating the first down-sampled signal for the time delay of the first oversampled signal relative the second oversampled signal comprises time-aligning the first down-sampled signal with the second down-sampled signal.

According to some embodiments, the first time delay is obtained from a channel analyser unit.

According to some embodiments, the first time delay is obtained from a channel estimation unit.

According to a second aspect there is provided a program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a computer program product comprising a non-transitory computer readable medium, having stored thereon a computer program comprising program instructions, the computer program being loadable into a data processing unit and configured to cause execution of the method of the first aspect or any of the above-mentioned embodiments when the computer program is run by the data processing unit.

According to a fifth aspect there is provided a control unit for a multi-antenna transmitter and receiver arrangement (MATARA), the MATARA comprising two or more antenna units, two or more transceivers, and two or more two or more analog to digital converters (ADCs) and the MATARA is comprisable in a wireless device (WD), the control unit configured to cause: reception of a first oversampled signal, wherein the first oversampled signal is an oversampled representation of an information signal comprised in a radio signal received by a first antenna unit; obtainment of a first time delay of the first oversampled signal relative a second oversampled signal, the second oversampled signal is an oversampled representation of the information signal comprised in the radio signal received by a second antenna unit; obtainment of a down-sampling, DS, offset based on the first time delay; and configuration of a first DS unit to down-sample the first oversampled signal to a first down-sampled signal in accordance with the DS offset, thereby compensating the first down-sampled signal for the time delay of the first oversampled signal relative the second oversampled signal.

According to a sixth aspect there is provided a wireless device (WD) comprising a multi-antenna transmitter and receiver arrangement (MATARA) and the control unit of the third aspect.

According to a seventh aspect there is provided a chip comprising the control unit (380) of the third aspect.

Effects and features of the second, third, fourth, fifth, sixth, and seventh aspects are fully or to a large extent analogous to those described above in connection with the first aspect and vice versa.

Embodiments mentioned in relation to the first aspect are fully or largely compatible with the second, third, fourth, fifth, sixth, and seventh aspects and vice versa.

An advantage of some embodiments is that power consumption is reduced or optimized (for a wireless device).

Another advantage of some embodiments is that all time delays (of the information signal comprised in a radio signal received at different antenna units) are accurately compensated for within the chip rate.

A further advantage of some embodiments is that a lower complexity system is provided.

Yet a further advantage of some embodiments is that compensation is provided separate from a converter unit. Thus, the compensation is made independent of the converter design. I.e., the compensation can be performed in a separate chip/unit/IP block in a chip other than the chip comprising the converter unit. Therefore, the power consumption may be optimized/improved separately for the compensation and for the converter unit, and the overall power consumption may be reduced.

Yet another advantage of some embodiments is that a more flexible/variable compensation is provided.

Yet another further advantage of some embodiments is that a higher resolution/accuracy is achieved/provided.

Yet further advantages of some embodiments are simplified circuit design, improved efficiency, and/or reduced circuit complexity.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Moreover, the term “configured” or “adapted” is intended to mean that a unit or similar is shaped, sized, connected, connectable or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a schematic drawing illustrating a wireless device according to some embodiments;

FIG. 1B is a flowchart illustrating some method steps according to some embodiments;

FIG. 2 is a schematic drawing illustrating a computer readable medium according to some embodiments; and

FIG. 3 is a flowchart illustrating actions/method steps implemented in a multi-antenna transmitter and receiver arrangement (MATARA) and/or by a control unit according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a processor/processing unit. The processor may be a digital processor. Alternatively, the processor may be a microprocessor, a microcontroller, a central processing unit, a co-processor, a graphics processing unit (GPU), a digital signal processor (DSP), an image signal processor, a quantum processing unit, or an analog signal processor. The processing unit may comprise one or more processors and optionally other units, such as a control unit. Thus, the processor may be implemented as a single-processor, a dual-processor system, or a multiprocessor system. Furthermore, the invention can also be practiced in distributed computing environments where certain tasks are performed by remote processing devices that are linked through a communications network, e.g., 5G, to one or more local processors. In a distributed computing environment, program modules can be located in both local and remote memory storage devices. Moreover, some processing (e.g., for the data plane) may be moved to a centralized node, such as a centralized transceiver node (TNode). For example, baseband processing and/or higher layer processing, such as processing at layers above the physical layer, may be moved to a cloud, such as an mmW RAN cloud (wherein processing is performed by cloud processors). Such a (mmW) cloud deployment may bring significant cost savings to the operator due to centralized processing, collaborative radio processing, and availability of cheap commodity hardware.

Below is referred to a baseband (BB) processor/processing unit. A BB processor is a processor specifically adapted for processing baseband signals/data.

Below is referred to a control unit. A control unit may be a processor or a processing unit.

Herein is referred to millimetre Wave (mmW) utilization, mmW communication, mmW communication capability and mmW frequency range. The mmW frequency range is from 24.25 Gigahertz (GHz) to 71 GHz or more generally from 24 to 300 GHz. The mmW frequency range may also be referred to as Frequency Range 2 (FR2).

Below is referred to a chip. A chip is an integrated circuit (chip) or a monolithic integrated circuit (chip) and may also be referred to as an IC, or a microchip.

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V21) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, and tablets.

Below is referred to a “transceiver node” (TNode). A TNode may be a radio unit (RRU), a repeater, a wireless node, or a base station (BS), such as a radio base station (RBS), a Node B, an Evolved Node B (eNB) or a gNodeB (gNB). Thus, a TNode may be a NW node. Furthermore, a TNode may be a BS for a neighbouring cell, a BS for a handover (HO) candidate cell, a radio unit (RRU), a distributed unit (DU), another WD (e.g., a remote WD) or a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports. Moreover, an antenna unit may be an antenna array, e.g., if analog beamforming is performed.

The polarization of an antenna refers to the orientation of the electric field of the radio wave transmitted by it and is determined by the physical structure of the antenna and its orientation. E.g., an antenna composed of a linear conductor (such as a dipole or whip antenna) oriented vertically will result in vertical polarization; if turned on its side the same antenna's polarization will be horizontal.

Herein is referred to a power delay profile (PDP). A PDP gives the intensity of a signal received through a multipath channel as a function of time delay. The time delay is the difference in travel time between multipath arrivals.

### Basic Concept

A basic concept of this invention is to add or subtract a time-varying (dithering) down-sampling sequence, in a down sampling unit, during down-sampling of a signal received by a first antenna unit (and further processed), thereby compensating for a time delay relative the signal received by a second antenna unit (which is different from the first antenna unit).

### Embodiments

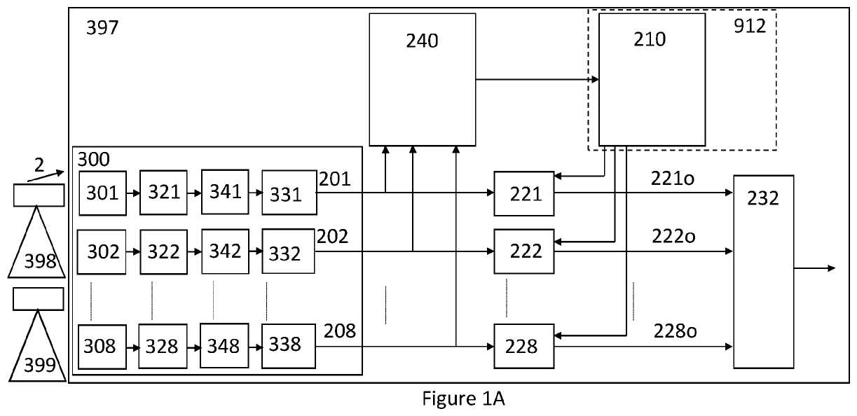

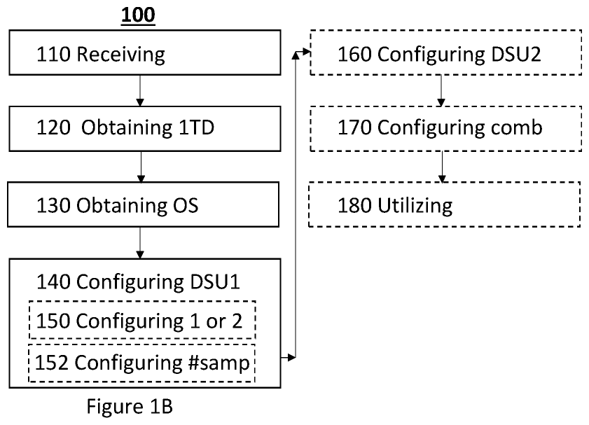

In the following, embodiments will be described where FIG. 1A illustrates a wireless device according to some embodiments and FIG. 1B illustrates some method steps according to some embodiments.

FIG. 1A illustrates a wireless device (WD) 397 according to some embodiments. The WD 397 comprises a multi-antenna transmitter and receiver arrangement (MATARA) 300. Furthermore, the WD 397 comprises a control unit (210). In some embodiments, the control unit is a processor, such as a baseband (BB) processor. Furthermore, in some embodiments, the MATARA 300 is connected or connectable to the control unit 210. Alternatively, the MATARA 300 comprises the control unit 210. The MATARA 300 comprises two or more antennas or antenna units 301, 302, . . . , 308. Furthermore, the MATARA 300 comprises one or two or more transceiver front ends 321, 322, . . . , 328. Each transceiver front end 321, 322, . . . , 328 comprises one or two or more transceivers. Furthermore, each of the transceiver front end 321, 322, . . . , 328 is connected to one respective antenna or antenna unit 301, 302, . . . , 308. The one or two or more transceiver front ends 321, 322, . . . , 328 are configured to receive radio/carrier signals/waves using/via the two or more antennas or antenna units 301, 302, . . . , 308. Moreover, the MATARA 300 may comprise two or more automatic gain controllers (AGCs), two or more low noise amplifiers (LNAs) and/or two or more variable gain amplifiers (VGAs). The MATARA 300 comprises two or more down-converters 341, 342, . . . , 348. Furthermore, each of the two or more down-converters 341, 342, . . . , 348 is connected to a respective transceiver front end 320, 321, . . . , 328. Moreover, the two or more down-converters 341, 342, . . . , 348 are configured to down-convert two or more carrier/radio signals/waves into/to baseband/information signals. The MATARA 300 comprises two or more analog-to-digital converters (ADCs) 331, 332, . . . , 338. Each ADC 331, 332, . . . , 338 is configured to convert an analog (down-converted) baseband/information signal into/to a digital baseband/information signal. Each of the ADCs 331, 332, . . . , 338 is (e.g., directly) connected to a respective down-sampling (DS) unit 221, 222, . . . , 228. Furthermore, in some embodiments, each of the ADCs 331, 332, . . . , 338 is (e.g., directly) connected to a channel analyser/analyzer unit (and/or a channel estimation unit) 240. The channel analyser unit 240 and/or the channel estimation unit is connected/connectable to the control unit 210. The control unit 210 is connected/connectable to and/or configured to control the two or more DS units 221, 222, . . . , 228. Moreover, each of the two or more DS units 221, 222, . . . , 228 is configured to produce a respective down-sampled signal (221o, 222o, . . . , 228o). Furthermore, each of the two or more DS units 221, 222, . . . , 228 is connected/connectable to a combiner 232. In some embodiments, the combiner 232 is an adder, a summing unit, an adding unit, or a summer. The combiner 232 is configured to combine (e.g., add together) the two or more down-sampled signals, e.g., by utilizing phase-coherent combining. Moreover, in some embodiments, the combiner 232 comprises a spatio-temporal filter. In these embodiments, the combiner performs scaling or filtering before the phase-coherent combining. Furthermore, in some embodiments, the control unit 210 is comprised in one or more chips 912. The one or more chips 912 may comprise the control unit 210 and optionally one or more of the MATARA 300, the channel analyser unit 240, the channel estimation unit, the two or more DS units 221, 222, . . . , 228, and the combiner 232. The WD 397 may be configured to communicate with (e.g., send and/or receive signals, such as radio signals 2, e.g., comprising baseband/information signals, to/from) one or more remote transceiver nodes (TNodes) 398, 399.

Referring to FIG. 1B, the method 100 is a method of compensating for a time delay of an information/baseband signal received by different antenna units 301, 302, . . . , 308 of a multi-antenna transmitter and receiver arrangement (MATARA) 300 (as part of a radio/carrier signal/wave 2). E.g., by the method an information signal received by a first antenna unit 301 (as part of a radio signal 2) is compensated for a time delay, present at the time of reception of the information signal, since a second antenna unit 302 (which is different from the first antenna unit 301) receives the information signal (as part of the radio signal) before the first antenna unit 301 receives the information signal. The time delay is caused e.g., by the first antenna unit 301 being located further away from the source (e.g., a remote TNode 398, 399) of the information signal than the second antenna unit 302. The method 100 comprises receiving 110 (at a first DS unit 221) a first oversampled signal 201 (i.e., receiving a radio signal 2, transmitted from a remote TNode 398, 399, by/at the first antenna unit 301 and a first transceiver front end 321; down-converting the received radio signal 2 to an analog baseband/information signal; and then analog-to-digital converting the baseband/information signal with a sampling frequency, which is higher than the Nyquist frequency). The first oversampled signal 201 is an oversampled representation of the information signal received (as part of the radio signal 2) by the first antenna unit 301. Furthermore, the method 100 comprises obtaining 120 a first time delay of the first oversampled signal 201 relative a second oversampled signal 202. The second oversampled signal 202 is an oversampled representation of the information signal received (as part of the radio signal 2) by the second antenna unit 302. Thus, the second oversampled signal 202 is different from the first oversampled signal 201. In some embodiments, the first time delay is obtained (e.g., by the control unit 210) from a channel analyser unit 240 (and/or from a channel estimation unit). As an example, the channel analyser unit 240 receives a plurality of oversampled baseband/information signals 201, 202, . . . , 208 from the ADCs 331, 332, . . . , 338; the channel analyser unit 240 analyses the plurality of oversampled baseband/information signals 201, 202, . . . , 208; the channel analyser unit 240 determines, based on the analysis, one or more time delays between the plurality of oversampled baseband/information signals 201, 202, . . . , 208 (e.g., utilizing the second oversampled signal 202 as a reference signal, the second oversampled signal 202 thus having a time delay of zero); and the channel analyser unit 240 sends the determined time delays to the control unit 210. Thus, obtaining 120 a first time delay of the first oversampled signal 201 relative a second oversampled signal 202 is performed by the control unit 210. In some embodiments, the channel analyser unit 240 performs analysis in the frequency domain. Alternatively, the channel analyser unit 240 performs analysis in the time domain. As an example (particularly suitable for orthogonal frequency-division multiplexing, OFDM, signals), the analysis is performed in the frequency domain. In the frequency domain the time delay may be observed as a (linear) phase shift over a particular frequency range and based on the size of the linear phase shift for a first and a second signal, the time delay of the first signal relative the second signal is obtained. Alternatively, the analysis is performed in the time domain. In the time domain the correlation between the received signals and known reference signals in the information signal is calculated/computed and a Power delay profile (PDP) is determined for the radio channel (e.g., a channel estimate). Based on the timing of PDP peaks in a first and a second signal, a time delay between the first and the second signal is determined. Moreover, the method 100 comprises obtaining 130, e.g., by the control unit 210, a down-sampling (DS) (time) offset based on the first time delay. In some embodiments, the DS offset is (e.g., directly) proportional to the first time delay. Moreover, in some embodiments, the DS offset is a real number, an integer, or a rational number. Furthermore, in some embodiments, the method 100 comprises obtaining a DS offset for each of the oversampled baseband/information signals 201, 202, . . . , 208 based on the one or more time delays between the plurality of oversampled baseband/information signals 201, 202, . . . , 208. In some embodiments, each of the DS offsets is (e.g., directly) proportional to a corresponding time delay. The method 100 comprises configuring 140 (by the control unit 210) a first down-sampling (DS) unit 221 to down-sample the first oversampled signal to a first down-sampled signal 221o in accordance with the DS offset, e.g., by applying the DS (time) offset to the first oversampled signal 201 during DS. Thereby, the first DS unit compensates the first down-sampled signal 221o for the time delay of the first oversampled signal 201 relative the second oversampled signal 202. In some embodiments, compensating the first down-sampled signal 221o for the time delay of the first oversampled signal relative the second oversampled signal comprises time-aligning the first down-sampled signal 221o with the second down-sampled signal 222o (or time-aligning the first oversampled signal 201 with the second oversampled signal 202). Moreover, in some embodiments, the method 100 comprises configuring 160 (by the control unit 210) a second DS unit 222 to down-sample the second oversampled signal to a second down-sampled signal 222o. Furthermore, in some embodiments, the method 100 comprises configuring (by the control unit 210) each of the DS units 221, 222, . . . , 228 to down-sample a corresponding oversampled signal to a respective down-sampled signal 221o, 222o, . . . , 228o in accordance with the corresponding DS offset. Thereby, each DS unit 221, 222, . . . , 228 compensates the corresponding down-sampled signal 221o, . . . , 228o for the time delay of the respective oversampled signal 201, . . . , 208 relative e.g., the second oversampled signal 202 (which may be selected to be a reference signal). In some embodiments, compensating the corresponding down-sampled signal 221o, . . . , 228o for the respective time delay of the corresponding oversampled signal relative the second oversampled signal comprises time-aligning the respective down-sampled signal 221o, . . . , 228o with the second down-sampled signal 222o (or time-aligning the respective oversampled signal 201, . . . , 208 with the second oversampled signal 202).

In some embodiments, the first oversampled signal comprises two or more groups of samples, each group comprising a first and a second sample. Alternatively, each group consists of a first and a second sample. In (any of) these embodiments, configuring 140 the first DS unit 221 to down-sample the first oversampled signal to a first down-sampled signal in accordance with the DS offset comprises: configuring 150 (by the control unit 210) the first DS unit to select for every group of samples either the first sample or the second sample in accordance with the DS offset. Thereby, the first down-sampled signal is compensated for the time delay of the first oversampled signal relative the second oversampled signal. As an example, the DS offset has been obtained as a real number, in this case 1.2 (for an OFDM signal oversampled a factor of two and having a signal length (FFT size) of N (N being e.g., 1024 or 2048). Therefore, the control unit 210 configures the first DS unit 221 to select the first sample 80% of the time and the second sample 20% of the time, e.g., selecting for the first 4 groups of samples the first sample and for a fifth group the second sample (and to repeat the selecting of the first sample for 4 groups and the second sample for 1 group for the rest of the samples). Selecting the first sample 80% of the time and the second sample 20% of the time is, in some embodiments, achieved by applying (adding or subtracting) a time-varying (dithering) down-sampling sequence having a sequence length (e.g., 1024 or 2048) and wherein the sequence consists of (or comprises) 80% first samples and 20% second samples (over the sequence length). Alternatively, selecting the first sample 80% of the time and the second sample 20% of the time is performed periodically, e.g., by selecting a first sample once followed by selecting the second sample 4 times consecutively and then repeating the selecting in the same manner. As another example, the DS offset has been obtained as a real number, in this case 1.8, e.g., for an OFDM signal oversampled a factor of two and having a signal length (FFT size) of N (N being e.g., 1024 or 2048). Therefore, the control unit 210 configures the first DS unit 221 to select the first sample 20% of the time and the second sample 80% of the time, e.g., selecting for the first group of samples the first sample and for the following 4 groups the second sample (and to repeat the selecting of the first sample for one group and the second sample for 4 groups for the rest of the samples). Selecting the first sample 20% of the time and the second sample 80% of the time is, in some embodiments, achieved by applying (adding or subtracting) a time-varying (dithering) down-sampling sequence having a sequence length (e.g., 1024 or 2048) and wherein the sequence consists of (or comprises) 20% first samples and 80% second samples (over the sequence length). Alternatively, selecting the first sample 20% of the time and the second sample 80% of the time is performed periodically, e.g., by selecting a first sample once followed by selecting the second sample 4 times consecutively and then repeating the selecting in the same manner. As yet another example, the DS offset has been obtained as 1 (an integer) or 1.0 (a real number). Therefore, the control unit 210 configures the first DS unit 221 to select the first sample 100% of the time and the second sample 0% of the time. As a further example, the DS offset has been obtained as 2 (an integer) or 2.0 (a real number). Therefore, the control unit 210 configures the first DS unit 221 to select the first sample 0% of the time and the second sample 100% of the time. In some embodiments, the control unit 210 configures each of the DS units 221, 222, . . . , 228 to select for every group of samples either the first sample or the second sample in accordance with the respective DS offset (e.g., as exemplified above for the first DS unit 221). Furthermore, in some embodiments, the method 100 comprises configuring 170 a combiner 232 to (phase-coherently) combine (e.g., add together) the second down-sampled signal 222o with the first down-sampled signal 221o (e.g., after scaling or filtering one or more of the first and second down-sampled signals 221o, 222o) to obtain a combined down-sampled signal. Moreover, in some embodiments, the method 100 comprises utilizing 180 the combined down-sampled signal as a representation of the information signal, e.g., for further processing, such as decoding, extracting information etc. Thus, in some embodiments, utilizing 180 comprises (or consists of) further processing of the combined down-sampled signal. As an example, utilizing 180 comprises (or consists of) decoding the combined down-sampled signal (and utilizing the decoded information). For this purpose, the WD 397 (and/or the MATARA 300) may comprise a decoder (not shown). As another alternative, or additionally, utilizing 180 comprises (or consists of) extracting information from the combined down-sampled signal (and utilizing the extracted information). For this purpose, the WD 397 (and/or the MATARA 300) may comprise an extractor or extracting circuitry (not shown). In some embodiments, utilizing 180 comprises (or consists of) decoding the combined down-sampled signal (and thus obtain decoded data), and extracting information from the decoded data. The extracted information (from the decoded data or from the combined down-sampled signal) may be utilized as speech, data (text, images, or video), control information or to initiate transmission (e.g., from the WD 397 to one or more remote TNodes 398, 399). By utilizing the combined down-sampled signal as a representation of the (received) information signal, accuracy is increased, e.g., since the combined (time-aligned or compensated) down-sampled signal is more accurate than any of the first and second down-sampled/oversampled signals taken alone as well as a directly combined signal combined from the first and second down-sampled signals (without applying any offset to any of the signals). In some embodiments, the method 100 comprises configuring the combiner 232 to (phase-coherently) combine (e.g., add together) all of the down-sampled signals to obtain a combined down-sampled signal (and utilizing 180 the combined down-sampled signal as a representation of the information signal).

In some embodiments, oversampling is performed with a first factor. In some embodiments, the first factor is an integer, such as an odd number/integer or an even number/integer. Alternatively, the first factor is a real number or a rational number. In these embodiments (in which oversampling is performed with a first factor), each group of the two or more groups of samples consists of (or comprises) a number of samples. The number of samples is two or more. Furthermore, the number of samples is in accordance with the first factor, i.e., the number of samples is selected (to be e.g., 2, 3, 4) based on the first factor. E.g., the number of samples in each group is selected so that the average down sampling for the two or more groups of samples is in accordance with the first factor. Thus, achieving maximum (reliable) DS while improving the accuracy. As an example, if the first factor is 2, then each group of samples is configured to consist of 2 samples. As another example, if the first factor is 4, then each group of samples is configured to consist of 4 samples. As yet another example, if the first factor is 2.5, then each 2 groups of samples (of the two or more groups of samples) are configured to consist of 5 samples, i.e., for each 2 groups, a first group of the 2 groups is configured to consist of 2 samples and a second group (different from the first group and following the first group or being consecutive/executive to the first group) is configured to consist of 3 samples (or the first group of the 2 groups is configured to consist of 3 samples and the second group is configured to consist of 2 samples). Thus, in some embodiments, configuring 140 the first DS unit 221 to down-sample the first oversampled signal to a first down-sampled signal in accordance with the DS offset comprises: configuring 152 (by the control unit 210) the first DS unit to select the number of samples for each group of the two or more groups of samples so that the average down sampling for the two or more groups of samples is in accordance with the first factor.

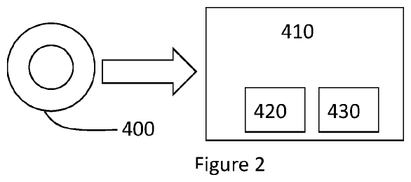

According to some embodiments, a computer program product comprising a non-transitory computer readable medium 200, such as a punch card, a compact disc (CD) ROM, a read only memory (ROM), a digital versatile disc (DVD), an embedded drive, a plug-in card, or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer or a computing device or the control unit 210. When loaded into the data processor 220, the computer program may be stored in a memory (MEM) 230 associated with or comprised in the data processor 220. According to some embodiments, the computer program may, when loaded into and run by the data processor 220, cause execution of method steps according to, for example, the method illustrated in FIG. 1B, which is described herein. Furthermore, in some embodiments, there is provided a computer program product comprising instructions, which, when executed on at least one processor of a processing device, cause the processing device to carry out the method illustrated in FIG. 1B. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1B.

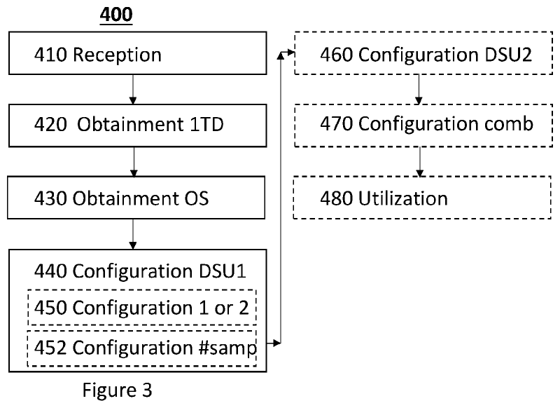

FIG. 3 illustrates actions/method steps caused by control unit 210 for a WD 397. The WD 397 comprises a multi-antenna transmitter and receiver arrangement (MATARA) 300. The MATARA 300 comprises two or more antenna units 301, 302, . . . , 308, two or more transceivers 321, 322, . . . , 328, and two or more two or more analog to digital converters, ADCs, 331, 332, . . . , 338. In some embodiments, the MATARA 300 and/or the WD 397 are as described above in connection with FIGS. 1A-1B. The control unit 210 is configured to cause reception 410 of a first oversampled signal, wherein the first oversampled signal is an oversampled representation of the information signal received by a first antenna unit 301. To this end, the control unit 210 may be associated with (e.g., operatively connectable, or connected, to) a first receiving unit (e.g., first receiving circuitry, a first receiver, or the first and second antenna units 301, 302 and the first and second transceiver front ends 321, 322). Furthermore, the control unit 210 is configured to cause obtainment 420 of a first time delay of the first oversampled signal relative a second oversampled signal, wherein the second oversampled signal is an oversampled representation of the information signal received by a second antenna unit 302. To this end, the control unit 210 may be associated with (e.g., operatively connectable, or connected, to) a first obtaining unit (e.g., first obtaining circuitry, a first obtainer, or the channel analyser unit 240). In some embodiments, obtainment 420 comprises obtainment of the first time delay from a channel analyzer unit 240 and/or from a channel estimation unit. Moreover, the control unit 210 is configured to cause obtainment 430 of a down-sampling (DS) offset based on the first time delay. To this end, the control unit 210 may be associated with (e.g., operatively connectable, or connected, to) a first obtaining unit (e.g., first obtaining circuitry, a first obtainer). The control unit 210 is configured to cause configuration 440 of a first DS unit to down-sample the first oversampled signal to a first down-sampled signal in accordance with the DS offset, thereby compensating the first down-sampled signal for the time delay of the first oversampled signal relative the second oversampled signal. To this end, the control unit 210 may be associated with (e.g., operatively connectable, or connected, to) a first configuring unit (e.g., first configuring circuitry, a first configurer).

In some embodiments, the control unit 210 is configured to cause configuration 450 (by the control unit 210) of the first DS unit to select for every group of samples either the first sample or the second sample in accordance with the DS offset. To this end, the control unit 210 may be associated with (e.g., operatively connectable, or connected, to) a second configuring unit (e.g., second configuring circuitry, or a second configurer) and/or a first selecting unit. Moreover, in some embodiments, the control unit 210 is configured to cause configuration 452 (by the control unit 210) of the first DS unit to select the number of samples for each group of the two or more groups of samples so that the average down sampling for the two or more groups of samples is in accordance with a first or a second factor. To this end, the control unit 210 may be associated with (e.g., operatively connectable, or connected, to) a third configuring unit (e.g., third configuring circuitry, or a third configurer) and/or a second selecting unit. Furthermore, in some embodiments, the control unit 210 is configured to cause configuration 460 (by the control unit 210) of a second DS unit 222 to down-sample the second oversampled signal to a second down-sampled signal 222o. To this end, the control unit 210 may be associated with (e.g., operatively connectable, or connected, to) a fourth configuring unit (e.g., fourth configuring circuitry, a fourth configurer). The first, second, third, and fourth configurer may be the same configure. In some embodiments, the control unit 210 is configured to cause configuration 470 (by the control unit 210) of a combiner 232 to (phase-coherently) combine (e.g., add together) the second down-sampled signal 222o with the first down-sampled signal 221o to obtain a combined down-sampled signal. To this end, the control unit 210 may be associated with (e.g., operatively connectable, or connected, to) a fifth configuring unit (e.g., fifth configuring circuitry, a fifth configurer or the first/second/third/fourth configurer). In some embodiments, the control unit 210 is configured to cause utilization 480 (by the WD 397 or a processor, such as a BB processor, thereof) of the combined down-sampled signal as a representation of the information signal. To this end, the control unit 210 may be associated with (e.g., operatively connectable, or connected, to) a first utilizing unit (e.g., first utilizing circuitry, a first utilizer, or a BB processor).

### List of Examples

Example 1. A method (100) of compensating for a time delay of an information signal comprised in a radio signal (2) received by different antenna units of a multi-antenna transmitter and receiver arrangement, MATARA, (300), the method comprising:
receiving (110) a first oversampled signal (201), wherein the first oversampled signal is an oversampled representation of the information signal received by a first antenna unit (301);
obtaining (120) a first time delay of the first oversampled signal (201) relative a second oversampled signal (202), wherein the second oversampled signal is an oversampled representation of the information signal received by a second antenna unit (302);
obtaining (130) a down-sampling, DS, offset based on the first time delay; and
configuring (140) a first down-sampling, DS, unit (221) to down-sample the first oversampled signal to a first down-sampled signal (221o) in accordance with the down-sampling offset, the first DS unit thereby compensating the first down-sampled signal (221o) for the time delay of the first oversampled signal (201) relative the second oversampled signal (202).

Example 2. The method of example 1, wherein the first oversampled signal comprises two or more groups of samples, each group comprising a first and a second sample, and wherein configuring (140) the first DS unit (221) to down-sample the first oversampled signal to a first down-sampled signal in accordance with the DS offset comprises:
configuring (150) the first DS unit to select for every group of samples either the first sample or the second sample in accordance with the DS offset, thereby compensating the first down-sampled signal for the time delay of the first oversampled signal relative the second oversampled signal.

Example 3. The method of example 2, wherein oversampling is performed with a first factor, wherein each group of the two or more groups of samples comprises a number of samples, and wherein the number of samples of each group is selected so that the average down sampling for the two or more groups of samples is in accordance with the first factor. Example 4. The method of any of examples 1-3, further comprising:
configuring (160) a second DS unit (222) to down-sample the second oversampled signal to a second down-sampled signal (222o);
configuring (170) a combiner (230) to combine the second down-sampled signal with the first down-sampled signal to obtain a combined down-sampled signal; and
utilizing (180) the combined down-sampled signal as a representation of the information signal.

Example 5. The method of example 4, wherein compensating the first down-sampled signal (221o) for the time delay of the first oversampled signal relative the second oversampled signal comprises time-aligning the first down-sampled signal (221o) with the second down-sampled signal (222o).

Example 6. The method of any of examples 1-5, wherein the first time delay is obtained from a channel analyzer unit (240).

Example 7. A computer program product comprising a non-transitory computer readable medium (200), having stored thereon a computer program comprising program instructions, the computer program being loadable into a data processing unit (420) and configured to cause execution of the method of any of examples 1-6 when the computer program is run by the data processing unit (220).

Example 8. A control unit (210) for a wireless device, WD, (397), the WD (397) comprising a multi-antenna transmitter and receiver arrangement, MATARA, (300), the MATARA (300) comprising two or more antenna units (301, 302, . . . , 308), two or more transceivers (321, 322, . . . , 328), and two or more two or more analog to digital converters, ADCs, (331, 332, . . . , 338), the control unit configured to cause:
reception (410) of a first oversampled signal, wherein the first oversampled signal is an oversampled representation of an information signal comprised in a radio signal (2) received by a first antenna unit;
obtainment (420) of a first time delay of the first oversampled signal relative a second oversampled signal, wherein the second oversampled signal is an oversampled representation of the information signal comprised in the radio signal (2) received by a second antenna unit;
obtainment (430) of a down-sampling, DS, offset based on the first time delay; and
configuration (440) of a first DS unit to down-sample the first oversampled signal to a first down-sampled signal in accordance with the DS offset, thereby compensating the first down-sampled signal for the time delay of the first oversampled signal relative the second oversampled signal.

Example 9. A wireless device, WD, (397) comprising a multi-antenna transmitter and receiver arrangement, MATARA, (300) and the control unit (210) of example 8.

Example 10. A chip (912) comprising the control unit (210) of example 8.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some actions/method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

### LIST OF SOME ACRONYMS AND ABBREVIATIONS THAT MAY APPEAR IN THE DESCRIPTION

3GPP—3rd Generation Partnership Project
5G—fifth generation
5G-NR (5G-New Radio) is a new RAT developed by 3GPP for the 5G mobile network
ADC—analog-to-digital converter
AGC—automatic gain controller
BB—baseband
BF—beamforming
BW—bandwidth
CSI-RS—channel state information reference signal
CU—control unit
DAC—digital-to-analog converter
DCI—downlink control information
DL-PRS—downlink positioning reference signal
DM-RS—demodulation reference signal
DS-down-sampling
FR1-Frequency Range 1
FR 1.5-Frequency Range 1.5
FR2-Frequency Range 2
Fe—Front end
FWA-Fixed Wireless Access
GNSS-Global navigation satellite system
GPS—Global Positioning System
IF—intermediate frequency
I/O—input/output
L1—Layer 1
LNA—Low Noise Amplifier
LO—Local Oscillator
LOS—Line of Sight
LTE—Long-Term Evolution
MAC—Medium Access Control
MATARA—multi-antenna transmitter and receiver arrangement
MIMO—multiple input, multiple output
mmW—millimeter wave
NAS—Non-access Stratum
nLoS—non-Line of Sight
OFDM—orthogonal frequency-division multiplexing
PA—power amplifier
PBCH—Physical Broadcast Channel
PCB—printed circuit board
PCell—primary cell
PDCCH—physical downlink control channel
PDP—Power delay profile
PDSCH—physical downlink shared channel
PHY—Physical Layer
PLL—phase locked loop
PSCell—primary secondary cell
PSS—primary synchronization signal
PT-RS—Phase Tracking Reference signal
PUCCH—physical uplink control channel
PUSCH—physical uplink shared channel
QCL—quasi co-located
QoS—quality of service
RAT—radio access technology
RRC—radio resource control
RSRP—Reference Signal Received Power
RSRQ—Reference Signal Received Quality
RSSI—Received Signal Strength Indicator
SCell—Secondary Cell
SNR—Signal-to-noise ratio
SSB—Synchronization Signal Block
SRS—sounding reference signal
SSS—secondary synchronization signal
STEF—spatio-temporal filter
STF—spatial transmission filter
TNode—transceiver node
VGA—variable gain amplifier
WD—wireless device

1. A method of compensating for a time delay of an information signal comprised in a radio signal received by different antenna units of a multi-antenna transmitter and receiver arrangement, MATARA, the method comprising:
receiving at a first down-sampling, DS, unit and by a channel analyzer unit via one of a set of analog to digital converters (ADCs), a first oversampled signal wherein the first oversampled signal is an oversampled representation of the information signal received by a first antenna unit;
analyzing, by the channel analyzer unit, the first oversampled signal;
determining, by the channel analyzer unit, based on the analyzing, a first time delay of the first oversampled signal relative a second oversampled signal, wherein the second oversampled signal is an oversampled representation of the information signal comprised in the radio signal received by a second antenna unit;
obtaining by a control unit, the first time delay from the channel analyzer unit
obtaining, by the control unit, a down-sampling offset based on the first time delay; and
configuring by the control unit the first DS unit to down-sample the first oversampled signal to a first down-sampled signal in accordance with the down-sampling offset, the first DS unit thereby compensating the first down-sampled signal for the time delay of the first oversampled signal relative the second oversampled signal.

2. (canceled)

3. The method of claim 1, wherein the first oversampled signal comprises two or more groups of samples, each group comprising a first and a second sample, and wherein configuring the first DS unit to down-sample the first oversampled signal to a first down-sampled signal in accordance with the DS offset comprises:
configuring the first DS unit to select for a number of groups of samples the first sample in accordance with the DS offset and to select for all other of the groups of samples the second sample in accordance with the DS offset, thereby compensating the first down-sampled signal for the time delay of the first oversampled signal relative the second oversampled signal.

4. The method of claim 3, wherein oversampling is performed with a first factor, wherein each group of the two or more groups of samples comprises a number of samples, wherein the number of samples is two or more, and wherein the number of samples of each group is selected so that the average down sampling for the two or more groups of samples is in accordance with the first factor.

5. The method of claim 1, further comprising:
configuring a second DS unit to down-sample the second oversampled signal to a second down-sampled signal;
configuring a combiner to combine the second down-sampled signal with the first down-sampled signal to obtain a combined down-sampled signal; and
utilizing the combined down-sampled signal as a representation of the information signal.

6. The method of claim 5, wherein compensating the first down-sampled signal for the time delay of the first oversampled signal relative the second oversampled signal comprises time-aligning the first down-sampled signal with the second down-sampled signal.

7-10. (canceled)

11. A control unit for a wireless device, WD, the WD comprising a channel analyzer unit, and a multi-antenna transmitter and receiver arrangement, MATARA, the MATARA comprising two or more antenna units two or more transceivers, and two or more two or more analog to digital converters, ADCs, the control unit configured to cause:
reception by the channel analyzer unit via one of a set of analog to digital converters (ADCs), of a first oversampled signal, wherein the first oversampled signal is an oversampled representation of an information signal comprised in a radio signal received by a first antenna unit;
analysis, by the channel analyzer unit, of the oversampled signal;
determination, by the channel analyzer unit, based on the analysis, a first time delay of the first oversampled signal relative a second oversampled signal, wherein the second oversampled signal is an oversampled representation of the information signal comprised in the radio signal received by a second antenna unit; and
wherein the control unit is configured to:
obtain from the channel analyzer unit, the first time delay;
obtain a down-sampling, DS, offset based on the first time delay; and
configure a first DS unit to down-sample the first oversampled signal to a first down-sampled signal in accordance with the DS offset, thereby compensating the first down-sampled signal for the time delay of the first oversampled signal relative the second oversampled signal.

12. The control unit of claim 11, wherein the first oversampled signal comprises two or more groups of samples, each group comprising a first and a second sample, and wherein configuring the first DS unit to down-sample the first oversampled signal to a first down-sampled signal in accordance with the DS offset comprises:
configure the first DS unit to select for a number of groups of samples the first sample in accordance with the DS offset and to select for the rest of the groups of samples the second sample in accordance with the DS offset.

13. (canceled)

14. A wireless device, comprising:
a multi-antenna transmitter and receiver arrangement, MATARA, comprising an analog to digital converter (ADC);
a channel analyzer unit configured to:
receive a first oversampled signal from the ADC, perform analysis of the oversampled signal, and determine, based on the analysis, a first time delay of the first oversampled signal relative a second oversampled signal; and
the control unit of claim 11; and
wherein obtainment of a first time delay comprises obtaining by the control unit the first time delay from the channel analyzer unit.

15. (canceled)

16. The wireless device of claim 14, wherein the channel analyzer unit performs the analysis in the frequency domain.

17. The wireless device of claim 14, wherein the channel analyzer unit performs the analysis in the time domain.
